(19) United States
(12) Patent Application Publication
(10) Pub. No.: US 2011/0077025 A1
(43) Pub. Date: Mar. 31, 2011

(54) Very low power locator application and apparatus for use with "I-Phone"-like cell phones

(76) Inventor: Susan Leeds Kudo, Pacific Palisades, CA (US)

(21) Appl. No.: 12/587,031

(22) Filed: Sep. 30, 2009

(51) Int. Cl. H04W 64/00

(52) U.S. Cl. 455/456.2

(57) ABSTRACT

This invention provides a method for locating a lost object by utilizing a stripped down cell-phone transceiver which is controlled in an on-off periodicity by an independent timer which is always on, and also has a low power GPS module. The invention provides for a software application to reside, for example, in an I-phone® and to interrogate the stripped down cell phone transceiver which is attached to the lost object and to display the lost object's location on a scalable map.

### FIELD OF THE INVENTION

The invention relates to the remote locating of objects to which the “locator” is attached.

This invention relates to GPS (Global Positioning Satellite) location determination.

This invention relates to an application which is suitable for “I-Phone®”-like cell phones in conjunction with the very low power locator apparatus.

### BACKGROUND OF THE INVENTION

It is easy to lose or misplace objects such as car/house keys, eyeglasses, women's pocketbooks/purses including one-of-a kind valuable objects. One such misplacement/lose occurs very locally, such as in the home. Another type of misplacement/lose occurs when outside the home.

The solution to the in-home lost object typically involves an application of a buzzer or sounding device in the attached finder. Lose or misplacement outside the home calls for a more sophisticated location method.

In all of these considerations one must be aware of size, weight and power requirements for the “locator.” The locator may be attached to a small object such as a set of keys, or, eyeglasses. It could also serve as an attachment to a dog's collar in the event a dog ran off or was taken.

It would be desirable, in conjunction with a “locator apparatus’ attached to the object to be located, to have an I-phone® or I-phone-like cell phone application available, which may be used to locate the lost object. Whenever reference is made to an I-phone®, that reference herein automatically includes any I-phone-like cell phone.

While automatic methods for finding such objects as cell-phones exist, a more general type of locator would be desirable to locate any lost object. The object is, of course, attached to the general type of locator.

The modern cell phone system provides a backbone for the anatomy of a lost object locator system. Calling a mobile (cell) phone requires the setting up of a connection from the caller to the destination. The cell phone is paged from a mobile base station (via a call initiated by a caller. One the cell phone receives a paging message it must make radio access to the base system.

In particular, a paging request to the mobile (cell) phone results in a channel request with a random 5-bit code (in an exemplary system). A channel is then assigned, i.e., access is granted (and includes the carrier and slot, as well as other attributes. An answering page is then sent. An authentication request goes out from the calling base station which is answered by the cell phone with an authentication response. Then there is a request to go to a cipher (encrypted) mode. The calling station acknowledges the cipher mode and the cell phone sets up for incoming call.

The base station (caller) confirms and assigns correct channel to the cell phone for its conversation. The cell phone acknowledges this assignment and the base (caller) sends an alert/ringing message. The cell phones connects up with a connect message sent to base, base responds with an “accept/connect” message and a two-way conversation proceeds on two related frequencies.

When the cell phone is originally turned on, it gets picked up by a paging message from its “cell” base and gets registered to its location area. Each bunch of “cells” (i.e., each area under the control of a separate local base) can execute a “hand-off” of the cellular activity while the cell phone is moving through various cell-phone system “cells.”

### SUMMARY OF THE INVENTION

The invention has a hardware locator apparatus working in conjunction with an ‘application’ for an I-phone®, or I-phone-like cell phone. The invention utilizes a very low duty cycle receiver-transmitter with an associated low power GPS ‘chip,’ all operating within a reduced function cell-phone, without speech encoding or decoding capability. The reduced cell-phone functionality needs to be able to transmit the simple data: GPS coordinates.

An internal timer partially wakes up the invention's receiver for a time window during which the receiver may receive a ‘total’ wake up call. The invention is woken-up via a call to its cell-phone-based simple receiver. Upon wakening, the apparatus activates a low-power GPS-reading chip, which then transmits the GPS coordinates along with device identification number to the caller. The information is returned to the I-phone®/I-phone-like cell-phone which hosts the display/locator application which plots the locator location on a map. This enables the caller to retrieve the ‘locator’ and the object to which it is attached. The locator apparatus main power requirements are such that the battery, whether rechargeable or replaceable primary, is very light weight relative to a full cell-phone battery. The battery may be rechargeable or a primary battery, such as a sulfur-air battery of the type used in a hearing aid. A very small secondary battery powers the timer and can be the equivalent of a very small watch battery.

The locator is initialized by making a single call to it so that it “registers” within its local cell area with the base and its data base.

The locator apparatus may have different size weights, principally due to the differences in battery capability. A very light weight apparatus may be more appropriate for eyeglasses, while a large dog may allow a heavier main battery to be used. This allows for less frequent recharging of the dog's locator battery, while eyeglasses may be plugged in each night for a recharge, along with, perhaps, the eyeglass owner's cell phone and a “blue-tooth” earpiece-worn cell-phone remote.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 (prior art) shows a full cell-phone receiver (GSM);

FIG. 2 (prior art) shows a full cell-phone transmitter (GSM);

FIG. 3 shows the receiver for an embodiment of the invention;

FIG. 4 shows the transmitter for an embodiment of the invention;

FIG. 5 shows the always on partial wake-up timer and its independent battery and its on-off switch, for an embodiment of the invention;

FIG. 6 shows the functional actions versus time when waking up the locator, for an embodiment of the invention

FIG. 7 shows the functional actions versus time when receiving external call and waking up GPS chip and sending GPS coordinates to I-phone®/I-phone-like cell-phone, for an embodiment of the invention;

FIG. 8A shows the software functions of the locator, for an embodiment of the invention;

FIG. 8B shows the functionality of the software aspect of the I-Phone®/I-Phone-like cell-phone, for an embodiment of the invention; and

FIG. 9 shows a diagram-like presentation on the I-Phone®/I-Phone-like cell-phone, for an embodiment of the invention.

### DETAILED DESCRIPTION OF THE BEST MODE OF THE INVENTION

The following description is of the best mode presently contemplated for carrying out the invention. This description is not to be taken in a limiting sense, but is merely made for the purpose of describing the general principles of the invention.

The thrust of this best mode of the invention is to focus on retaining a “bare-bones” cell-phone system structure and operability, with a very reduced duty cycle and power requirements. The essential lowering of the power requirements entail a lowering of weight requirements which is a qualitative functional change in that it allows the functionality of the invention herein to be attached to a light weight object, such as eyeglasses, while allowing a slightly heavier version, with a resultant larger battery, for example, for a dog's collar attachment, allowing for a missing dog to be located. A larger batterey in this instance stands for a reduced rate of recharging.

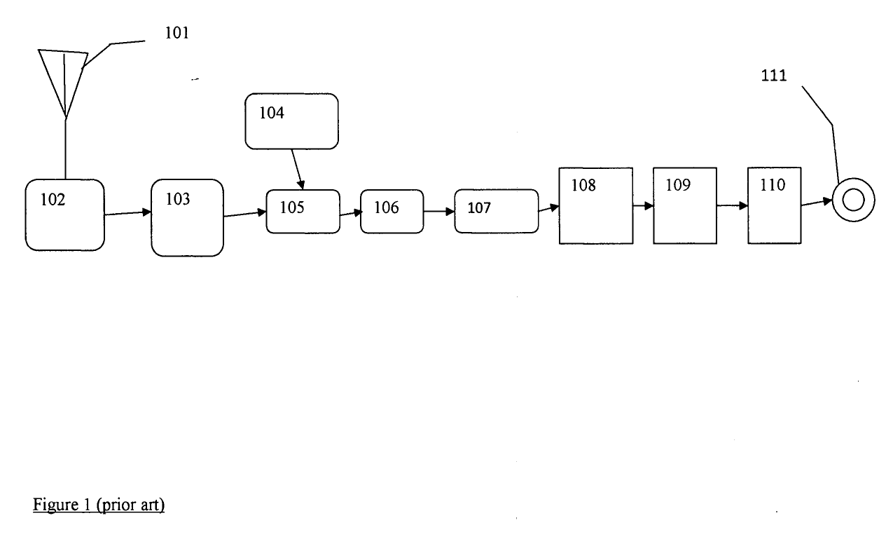

To start with, a typical cell-phone receiver (here, a GSM category receiver) shown in FIG. 1 (prior art) has an antenna 101 and a transmit-receiver switch 102 to keep the high-power transmitted signal out of the receiver's lower-power innards. Further, the receiver has a band filter 103, a preamplifier 104 and a mixer 105 which has a local oscillator 104 feeding into it for carrier selection (i.e., tuning). The basic receiver structure is a super-heterodyne, originally invented by the pioneer radio inventor Col. E. H. Armstrong.

The super-heterodyne intermediate frequencies (IF) are fed into IF amplifiers 106 which are then detected by the FM (frequency modulated) detector 107, where the information is stripped from the FM carrier signal.

In the ordinary GSM cell phone receiver, an adaptive equalizer 108 feeds into a digital processor 109 (including frame bits removed, bit de-interleaving, error protected decoding, etc.) and the digital to analog decoder 110 which then operates a speaker or earphone 111.

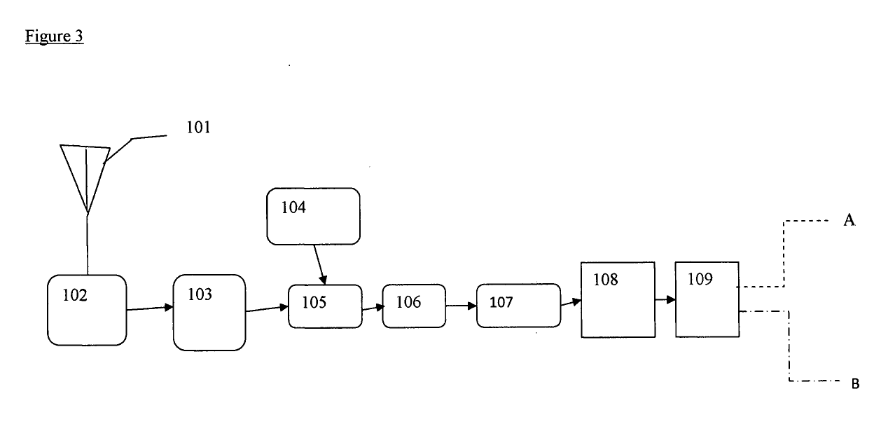

FIG. 3 shows the receiver as configured for the invention, herein, the locator: The antenna 101, the transmit-receive switch 102, the band filter 103, the mixer 105 fed by the local oscillator 104 are all retained. Further aspects of the basic receiver retained are the intermediate frequencies (IF) amplifiers 106, and the FM detector 107.

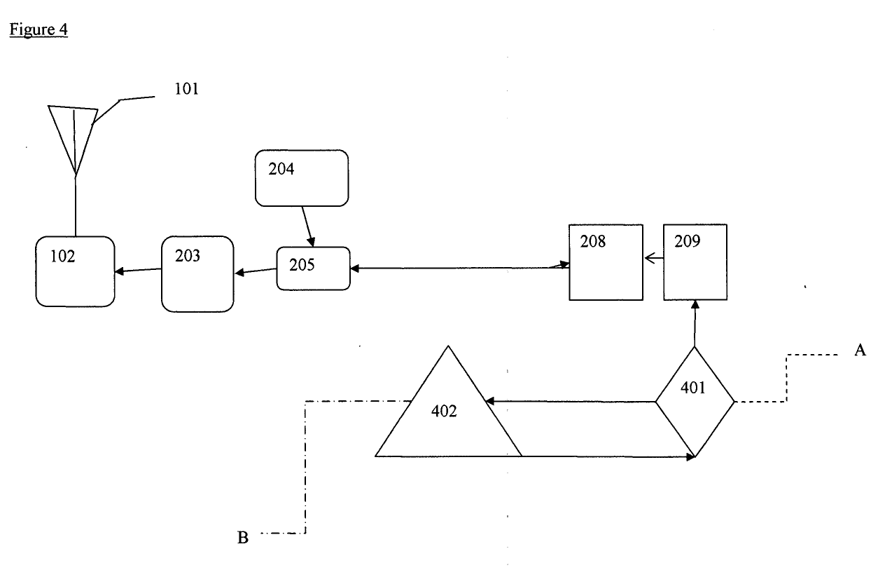

The final stage functionality retained may include the adaptive equalizer 108. A digital processor 109 is retained. The digital processor 109, in addition to handling normal cell phone system demands (as examined below, for example, “setting up” a cell phone call reception and transmission), also acts to wake up the GPS (global positioning satellite) chip, 402, FIG. 4, (link “B” to transmitter, FIG. 4) and to acquire and transmit (module 401, FIG. 4, and link “A” to the transmitter and GPS chip 402, FIG. 4) the acquired GPS coordinates to the calling phone. The GPS coordinates are transmitted as data.

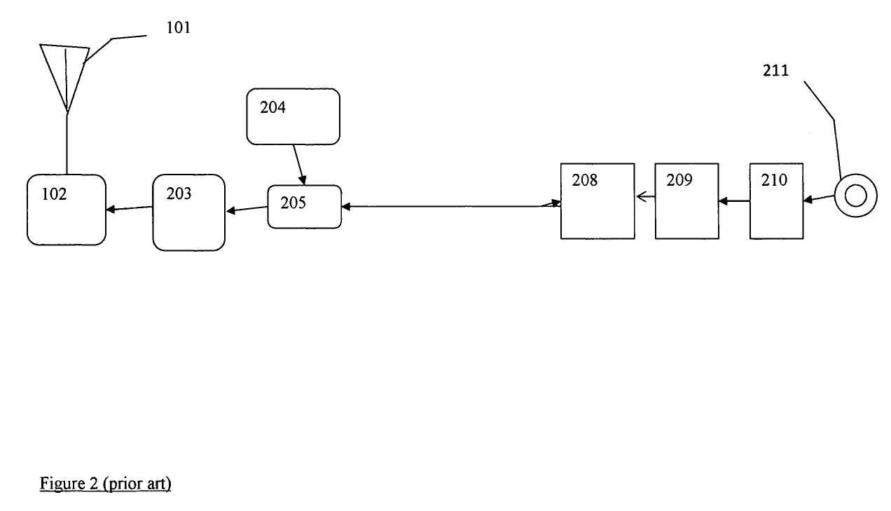

FIG. 2 (prior art) shows an exemplary GSM cell phone transmitter. The same cell phone antenna 101 as in the receiver (101, FIG. 1) is retained and the same transmit-receive switch 102 is retained as in the receiver (102, FIG. 1). Viewing the remainder of the transmitter (FIG. 2) from right to left, first encountered is a microphone 211 which feeds an analog-to-digital encoder 210. The next encountered is the digital processor 209 which may be identified with the digital processor 109 of the receiver (FIG. 1). Showing this digital processor 209 is to emphasize the outgoing processing may normally include additional functionality associated with transmitting a voice as well as data message. A first modulator 208 is fed by a first transmitter local oscillator (not shown). This signal is then fed to an up-converting mixer 205 fed by a second local oscillator 204 which feeds into an RF (radio frequency) power amplifier 203. At this point the transmitter-receiver switch 102 blocks the amplified RF signal from the receiver and the RF is transmitted out the antenna 101.

FIG. 3 shows the modified cell phone, described above.

FIG. 4 shows the modified transmitter utilized by the locator. The locator functionality shows a buffering capable module/chip/sub-chip 401 which upon receipt of a signal from the receiver (FIG. 3, link “A”) sends the acquired GPS coordinates to the remainder of the transmitter (described below) wherein it is transmitted to the calling phone.

The GPS module 402 is woken up by receipt of a signal from the receiver (FIG. 3, link “B”). When woken up, the GPS acquires its GPS coordinates from a GPS satellite, and then makes these coordinates available to the buffering functionality 401. At the same time, it adds an enabling functionality to the buffering functionality 401 to enable the transmitting process of the buffered information 401 to begin.

This transmitting process moves through the remaining locator transmitting functionality: the transmitting digital processor 209 (which may be identified with the receiver digital processor 109, FIGS. 1 and 3), the first modulator 208 (with a first local oscillator, not shown), and then to an up-converter 205 with a second local oscillator 204 and thence to a band filter 203 and through the transmit-receiver switch 102 to the antenna 101.

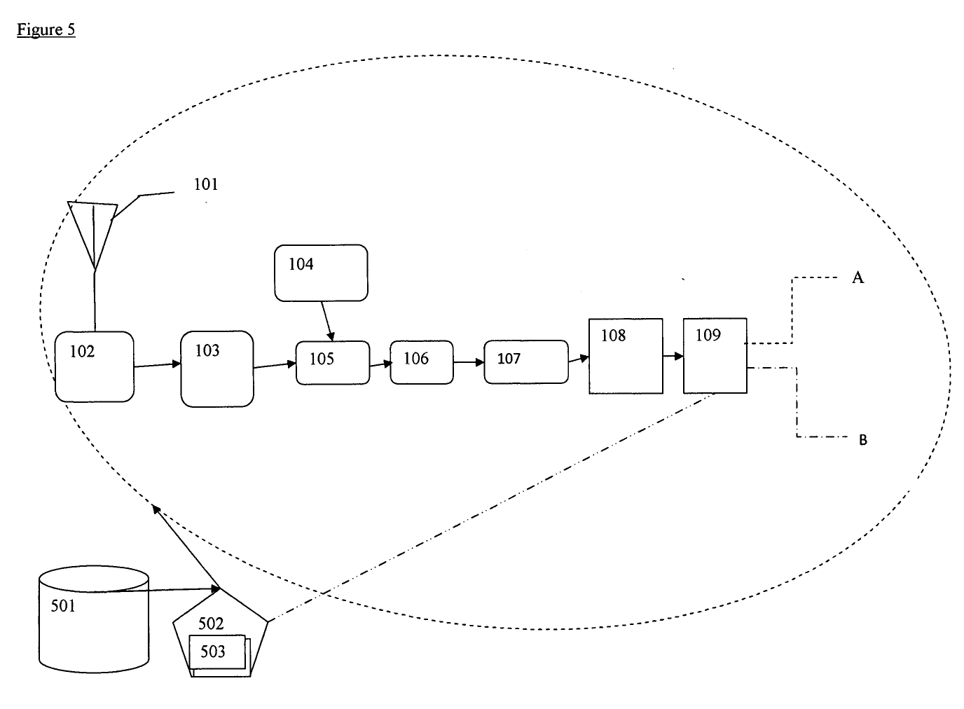

FIG. 5 shows the overall duty cycle which is controlled by a timer 502 which operates off its own very small and light-weight battery 503. One might compare this aspect to a very small watch battery and a very small and light weight timer.

When the timer 502, which stays on continuously powered by its separate battery 503, allows the receiver mechanism to turn on periodically, the main battery 501 is brought on-line and powers up the receive section of the locator. Show is the basics of FIG. 3, namely: antenna 101, transmit-receive switch 102, band filter 103, mixer (down-converter) 105 with local oscillator 104, intermediate frequencies (IF) amplifiers 106, frequency modulation (FM) detector 107, adaptive receiver 109 and links “A and “B” to the GPS chip (402, FIG. 4) and to the buffering functionality (401, FIG. 4), respectively.

The time periodicity when the timer 502 turns on the main battery 501 is settable. For example, the locator might be placed in an active receive mode for 5 minutes every hour. That requires an incoming call to be made to it within that five minute interval beginning on each hour. The setting of this feature depends on the desirability of keeping the duty cycle low while having the convenience of initiating a location search for the missing object attached to the locator.

The timing and periodicity may be set at the factory, or, in conjunction with a chart indicating how often to recharge the main locator battery 501, it may be set by the locator owner.

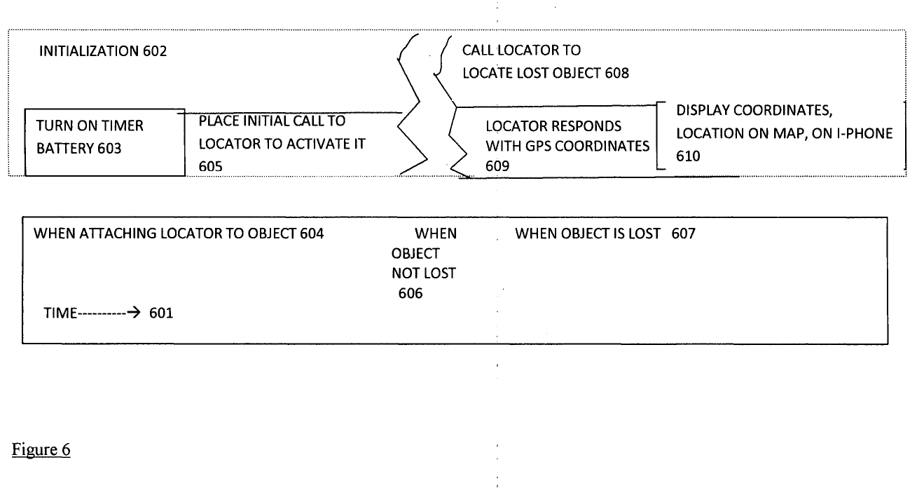

FIG. 6 is a diagram of the function versus time. Time 601 is shown at the bottom horizontal layer. When the object is first taken out of its box and attached 604 to an object to be located, the process of initialization 602 begins. The timer battery 503 is turned on 603. And an initial call to the locator is made to activate it 605.

Activating the locator with a telephone call results in its automatic registration in the tables of the local base station/area controller, in accordance with the manner in which a regular, full-up cell phone is registered.

When the object is not lost 606, nothing happens beyond the periodic turning on, for a limited period, of the locator receive functionality. Eventually, the locator main battery 501 must be recharged. This might be shown by a low power led (light emitting diode) flashing for a while when the main battery power is below a certain level, as known in the arts.

If the object attached to the locator is lost 607, a call is placed to the locator 608 and the locator responds with the GPS coordinates 609. The coordinates are displayed on a map display 610, on an I-phone® 610, for example.

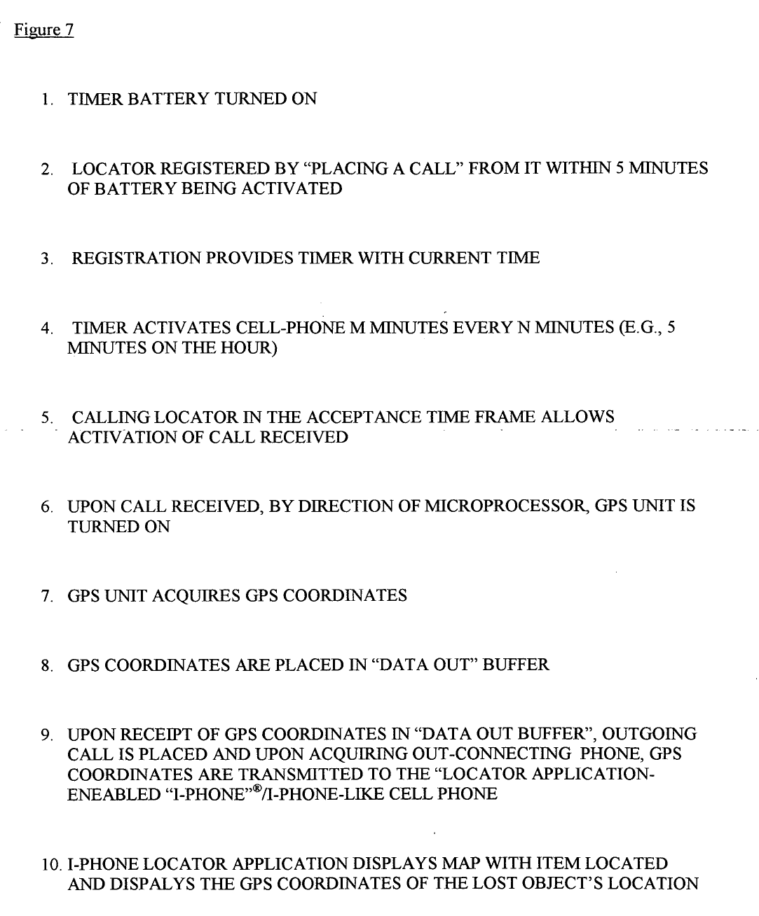

The sequence of events is summarized in words in FIG. 7.

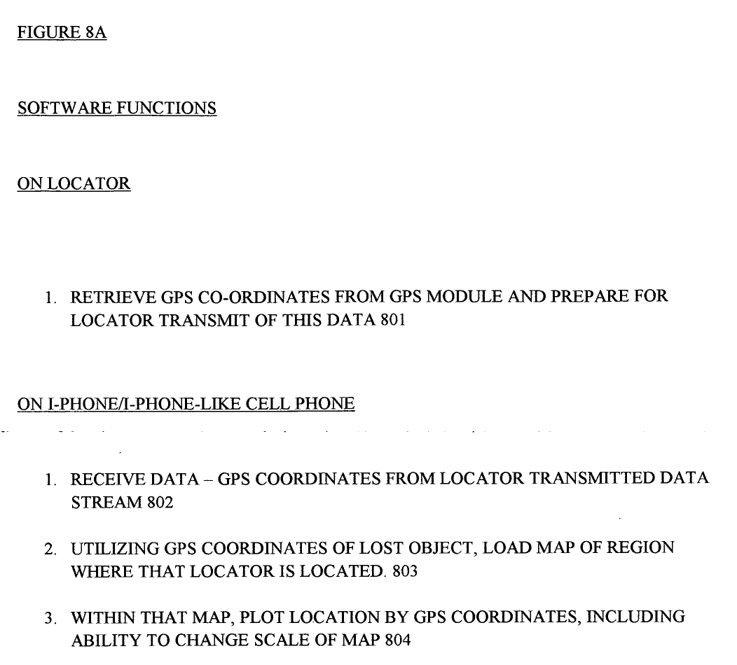

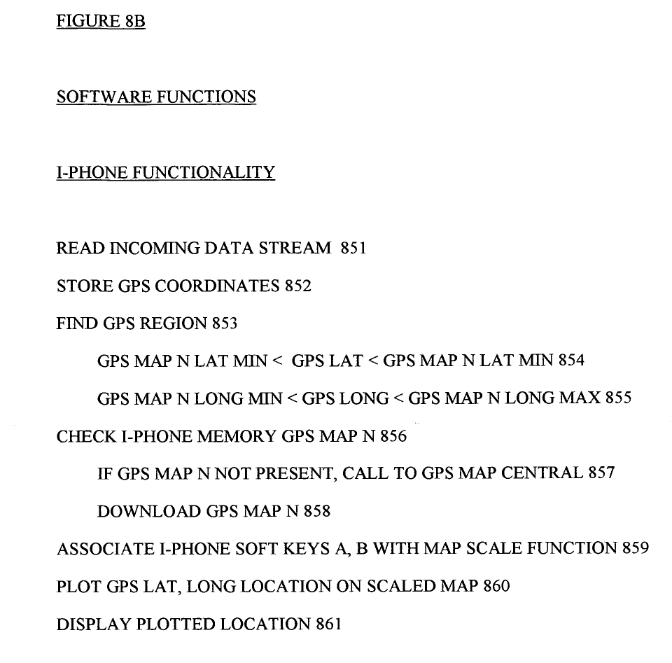

The software functions embedded in the locator and the locator I-phone® application are shown in FIG. 8A. On the locator, retrieving the GPS coordinates from a GPS module and preparing or a locator transmission of this data 801 can be done by a software function of the digital processor (209, FIG. 4).

The I-phone® application has the functionality to receive the GPS coordinates 802 which has been sent as data in response to the call initiated by the I-phone® in its attempt to locate the lost object.

The GPS coordinates are then used to determine the region of map which is needed to display the lost object's coordinates and is loaded for display 803.

The GPS coordinates of the lost object are then located within the map, all being displayed on the I-phone® in varying degrees of scale, controlled by keys on the I-phone® 804.

FIG. 8B shows more detail of the I-phone® application functionality. It is understood in the arts how to transfer the listed functionality to the I-phone® coding. First the incoming data stream is read 851. Then the GPS coordinates are stored 852. The GPS region corresponding to a stored map is determined by examining the maximum and minimum coordinates of a GPS map 853. Specifically the GPS latitude is bounded 854. Similarly, the GPS longitude is bounded 855.

The cell phone memory is examined to see if an appropriate map is already downloaded to its memory 856. If not, a GPS map repository is called 857 and the appropriate GPS map is downloaded 858.

Two soft keys of the I-phone® are assigned “increasing map resolution” and “decreasing map resolution” 859.

The GPS latitude and longitude are plotted on a scaled map 860 and the plotted location is displayed on the I-phone® 861.

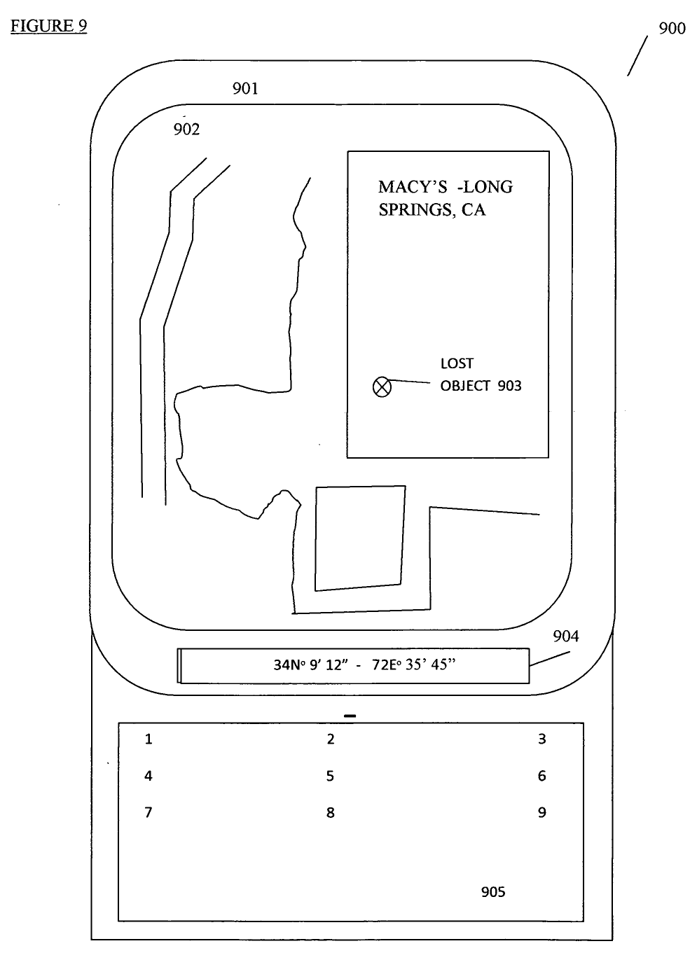

FIG. 9 is a pictorial diagram representation of how a lost object might appear on a map background of the lost objects location. The I-phone®/I-phone-like cell phone 900 has a display 901 which has a scaled map of the lost object 903 and a display of the GPS coordinates of the locator 904. The keyboard 905 and other functions of the cell phone shown are sketched 905, without detail.

Not shown is an additional feature which may be incorporated into the functions of the locator. This additional feature is a sound generator for locating the object when it is in the same room or apartment, for example, eyeglasses or keys. This is a convenience feature which may operate on a separate, removable battery. This functionality may be activated along with the regular functionality by initiating a call to the locator. It amounts to adding back the ringing feature which is otherwise not needed in the generic operation of the locator, and is otherwise omitted to conserve power.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention.

It is claimed that:

1. A locator apparatus, comprising a hardware unit and a software application for an I-phone® or I-phone-like cell phone: the hardware unit further comprising a stripped down cell-phone super-heterodyne transceiver;
the stripped down hardware unit being stripped of voice reception/transmission capability;
the hardware unit, further comprising:
a low power GPS module;
a separate timer controlling the on-off duty cycle of the cell-phone part of the hardware unit and the low power GPS module;
the timer having a separate, small, light weight, low power battery;
the timer always being on;
the software application being a code residing on a fixed memory as a hardware configuration of elements of the memory, which might include transitor states;
the software application capable of interrogating the hardware module;
the software application capable of receiving the hardware unit's GPS coordinates; and
the software unit being capable of displaying the hardware unit's GPS coordinates on a map.

2. A locator apparatus, comprising a hardware unit and a software application for an I-phone® or I-phone-like cell phone.

3. The apparatus of claim 2, further comprising:
the hardware unit further comprising a stripped down cell-phone super-het erodyne transceiver; and
the stripped down hardware unit being stripped of voice reception/transmission capability.

4. The apparatus of claim 3, further comprising:
a low power GPS module.

5. The apparatus of claim 4, further comprising:
a separate timer controlling the on-off duty cycle of the cell-phone part of the hardware unit and the low power GPS module.

6. The apparatus of claim 5, further comprising:
the timer having a separate, small, light weight, low power battery wherein the timer is always on.

6. The apparatus of claim 2, further comprising:
the software application being a code residing on a fixed memory as a hardware configuration of elements of the memory, which might include transitor states;
the software application capable of interrogating the hardware module;
the software application capable of receiving the hardware unit's GPS coordinates, upon interrogation; and
the software unit being capable of displaying the hardware unit's GPS coordinates on a map.

7. The apparatus of claim 7, further comprising:
the map wherein the map may be displayed in different, selectable resolutions.

8. The apparatus of claim 8, further comprising:
the selection of the map resolution is selectable by assignable soft keys of the I-phone® or I-phone-like cell phone.

9. The apparatus of claim 8, further comprising:
a sound generating capability upon interrogation.

10. The apparatus of claim 9 wherein the sound generating capability is supplied by
power from an additional removable and replaceable battery

11. A method for locating a lost object comprising interrogating an apparatus with basic cell phone functionality by an I-phone®/I-phone-like cell phone, comprising:
powering on the apparatus periodically for a fraction of an hour;
including a low power GPS module on the basic cell phone apparatus;
responding to an interrogation only during a powered-on time frame; and
acquiring GPS coordinates of the interrogated apparatus when interrogated.

12. The method of claim 11, further comprising:
plotting the lost objects coordinates on a map on the I-phone®/I-phone-like cell phone.

13. The method of claim 12, further comprising:
designating one or more soft keys of the I-phone®/I-phone-like cell phone to control map scale,
selecting scale of map

14. The method of claim 11, further comprising:
providing capability of generating sound by ringing basic cell phone apparatus.

15. The method of claim 11, further comprising:
providing capability of generating sound by separate sound source with a removable and replaceable battery.
